(19) United States
(12) Patent Application Publication
(10) Pub. No.: US 2007/0038801 A1
(43) Pub. Date: Feb. 15, 2007

(54) CONTROL CIRCUIT, ELECTRONIC DEVICE USING THE SAME, AND FIRMWARE UPDATE METHOD

(75) Inventor: Satomi TANAKA, Kyoto (JP)

Correspondence Address: ROHM CO., LTD.;C/O KEATING & BENNETT, LLP, 8180 GREENSBORO DRIVE, SUITE 850, MCLEAN, VA, 22102, US

(73) Assignee: ROHM CO., LTD., Ukyo-ku (JP)

(21) Appl. No.: 11/463,385

(22) Filed: Aug. 9, 2006

(30) Foreign Application Priority Data
Aug. 9, 2005 (JP) 2005-230979

(51) Int. Cl. G06F 12/00

(52) U.S. Cl. 711/103

(57) ABSTRACT

A control circuit for updating firmware includes a CPU for performing processing on the basis of firmware stored in a flash ROM and writes updated firmware, which is an updated new firmware, into a file system region of the flash ROM that is accessible to the user. Furthermore, the CPU copies the updated firmware written into the first region into a non-file system region of the flash ROM that is not accessible to the user. Moreover, the CPU reads out the updated firmware that has been copied into the second firmware storage region, and operates the electronic device on the basis of this read updated firmware.

### BACKGROUND OF THE INVENTION

1. Field of the Invention

The present invention relates to a technique of updating firmware for an electronic device including a nonvolatile memory.

2. Description of the Related Art

Firmware is stored in memories mounted on various electronic devices such as audio players and digital cameras, and these electronic devices operate on the basis of this firmware. There are cases in which firmware is updated by manufacturers. Users obtain such updated firmware, for example, from the internet or recording media such as CD-ROMs, and improve the functions of the electronic devices by updating the firmware. Generally, the user saves an updated firmware file on a computer, and updates the firmware of the electronic device connected to this computer by using updating-dedicated software. Japanese Patent Application Kokai No. 2002-202896 discloses a technique in which updated data is transmitted to a device using a device driver contained in a computer, and the firmware of this device is thus updated.

However, in cases where firmware is updated using updating-dedicated software, it is necessary for manufacturers of electronic devices to develop updating-dedicated computer software and to perform maintenance work for this updating-dedicated computer software in accordance with the firmware update. The efforts involving such software development and maintenance work are not necessarily negligible. Furthermore, users must obtain or update such updating-dedicated computer software every time any maintenance work is performed.

### SUMMARY OF THE INVENTION

Preferred embodiments of the present invention update firmware without using any updating-dedicated computer software.

A first preferred embodiment of the present invention relates to a control circuit for performing processing on the basis of firmware that is stored in a nonvolatile memory. This control circuit includes a write portion for writing updated new firmware into a first region of the nonvolatile memory that is accessible to the user, a copy portion for copying the firmware written into the first region into a second region of the nonvolatile memory that is not accessible to the user, and a control portion for reading out the firmware copied into the second region, and operating an electronic device mounting this control circuit on the basis of the read firmware.

In a preferred embodiment, when the firmware is written into the first region, the copy portion copies this firmware from the first region into the second region, and the control portion reads out this firmware, and operates the electronic device. That is, once the firmware is written into the first region, the user can update the firmware without using any updating-dedicated computer software.

The second region of the nonvolatile memory includes a plurality of firmware storage regions for storing the firmware, the control circuit further includes a determination portion for determining the newest firmware storage region that stores the newest firmware among the plurality of firmware storage regions, and the copy portion may copy the firmware into a firmware storage region other than the newest firmware storage region that is determined by the determination portion.

The control portion may read out the newest firmware among the firmware versions stored in the plurality of firmware storage regions, and operates the electronic device on the basis of the newest read firmware.

In another preferred embodiment, the copy portion copies the firmware into a firmware storage region other than the newest firmware storage region. As a result, there is no loss of the firmware that is the newest prior to the update, so that the use of the electronic device based on the firmware that is the newest before the update can be ensured even if it has failed to copy the firmware.

When there is a damaged firmware storage region among the plurality of firmware storage regions, the copy portion may copy the firmware into a firmware storage region other than the damaged firmware storage region.

In this preferred embodiment, because the firmware is not copied into the damaged firmware storage region, firmware update failure can be avoided.

When there is only one storage region operating normally among the plurality of firmware storage regions, the copy portion may terminate copying the firmware.

In another preferred embodiment, in cases where there is only one firmware storage region that is free of damage, the copy portion stops copying the firmware. As a result, it is possible to prevent the electronic device from not operating due to the firmware update failure caused by the failure to copy the firmware.

The copy portion may copy the firmware into the firmware storage region under the condition that a specified operation is performed by the user.

In this preferred embodiment, when the user performs a specified operation in order to update the firmware, the copy portion copies the firmware. As a result, it is possible to avoid automatic updating in cases where the user does not wish to update the firmware.

The control circuit may be integrated on a single semiconductor substrate. Furthermore, the term “integrated” includes a case in which all of the constituent elements of the circuit are provided on the semiconductor substrate or a case in which major constituent elements of the circuit are integrated on the semiconductor substrate, and portions of the resistors and capacitors may be provided on the outside of the semiconductor substrate for circuit constant adjustment. The circuit area can be reduced by integrating the control circuit as a single LSI (large scale integration) chip, for example.

Another preferred embodiment of the present invention relates to an electronic device. This electronic device includes the above-mentioned control circuit, a nonvolatile memory for storing the firmware in the first region and audio data in the second region, and an audio output portion for replaying the audio data stored in the second region. In this preferred embodiment, the user can update the firmware without using any updating-dedicated computer software.

Another preferred embodiment of the present invention relates to a firmware update method for a device including a nonvolatile memory. This update method includes a write step in which updated new firmware is written into a first region of the nonvolatile memory that is accessible to the user, and a copying step in which the firmware written into the first region is copied into a second region of the nonvolatile memory that is not accessible to the user.

In this preferred embodiment, after the firmware is written into the first region in the write step, this firmware is copied into the second region in the copying step. As a result, the user can update the firmware without using any updating-dedicated computer software.

The second region of the nonvolatile memory includes a plurality of firmware storage regions for storing the firmware, and the method further includes a determination step in which the newest firmware storage region that stores the newest firmware is determined among the plurality of firmware storage regions, and in the copying step, the firmware may be copied into a firmware storage region other than the newest firmware storage region determined in the determination step.

In a preferred embodiment, the firmware is copied into a firmware storage region other than the newest firmware storage region in the copying step. As a result, there is no loss of the firmware that is the newest prior to the update, so that the electronic device can be operated on the basis of the firmware that is the newest before the update.

Furthermore, the constituent elements described above may be arbitrarily combined, and preferred embodiments of the present invention may be changed among the method, device, system, computer program, and the like.

With the control circuit of the preferred embodiments of the present invention, the user can update firmware without using any updating-dedicated computer software.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram showing the construction of the electronic device of a preferred embodiment of the present invention.

FIG. 2 is a block diagram showing the construction of the flash ROM of a first preferred embodiment of the present invention.

FIG. 3 is a diagram showing the concept of the first firmware update of a first preferred embodiment of the present invention.

FIG. 4 is a diagram showing the concept of the second firmware update of a first preferred embodiment of the present invention. FIG. 5 is a flow chart showing the updating of firmware of a first preferred embodiment of the present invention.

### DETAILED DESCRIPTION OF PREFERRED EMBODIMENTS

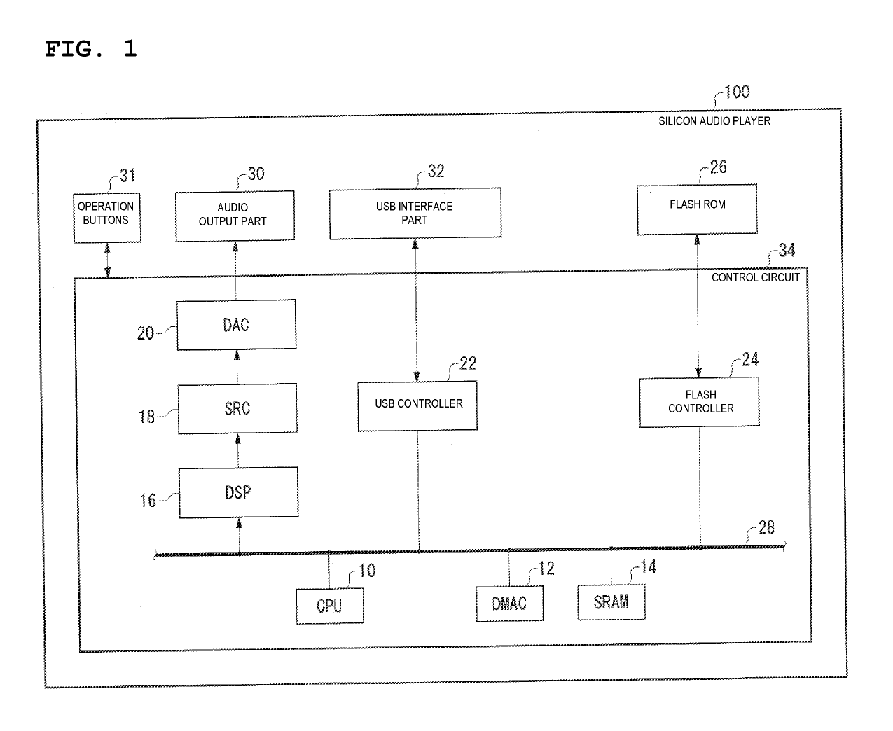

FIG. 1 is a block diagram showing the construction of an electronic device of a first preferred embodiment. The electronic device includes a memory for a audio player, a transceiver, a two-dimensional bar code reader, or any other suitable electronic device, and is controlled by firmware stored in the memory. In the present preferred embodiment, description is given assuming that the electronic device is an audio player, but the electronic device is not limited to this preferred embodiment.

An audio player 100 preferably includes a control circuit 34, a flash ROM (read only memory) 26, an audio output portion 30, operation buttons 31, and a USB (universal serial bus) interface 32.

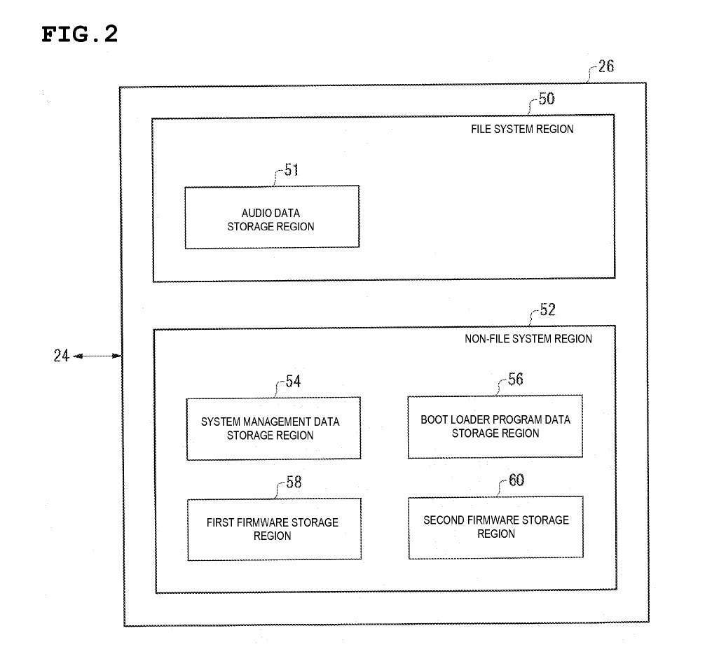

The control circuit 34 controls the entire audio player 100. The details of the control circuit 34 will be described below. The control circuit 34 is preferably integrated on a single semiconductor substrate. The flash ROM 26 is a nonvolatile memory such as an NAND-type flash memory, NOR-type flash memory, or any other suitable memory. The flash ROM 26 stores data such as firmware and audio data. The writing and reading of such data are performed by the control circuit 34. The detailed construction of the flash ROM 26 will be described below with respect to FIG. 2. The audio output portion 30 replays audio data that is read out from the flash ROM 26 by the control circuit 34. The operation buttons 31 are buttons that the user directly operates the audio player 100; for example, these buttons include a power button, a replay button, a replay stop button, and the like. The USB interface 32 connects the audio player 100 via a USB port to an external electronic device such as a computer (not shown). The firmware and audio data are transferred from the external computer to the flash ROM 26 via the USB port.

In the present preferred embodiment, the updating of the firmware stored in the flash ROM 26 will be described.

The control circuit 34 includes a CPU (central processing unit) 10, a DMAC (direct memory access controller) 12, an SRAM (static random access memory) 14, a DSP (digital signal processor) 16, an SRC (sample rate converter) 18, a DAC (digital-analog converter) 20, a USB controller 22, a flash controller 24, and a bus 28.

The CPU 10 is a processing unit that carries out the processes of the audio player 100 as a whole. The DMAC 12 is connected to the CPU 10, SRAM 14, and flash ROM 26 via the bus 28, directly accesses the SRAM 14 and flash ROM 26 in accordance with the instructions from the CPU 10, and performs data transfer among these components. The SRAM 14 temporarily saves data that is transferred via the bus 28, e.g., firmware, audio data, or the like, that is read out from the flash ROM 26.

The USB controller 22 controls the data transfer between the USB interface 32 and the control circuit 34. The flash controller 24 controls the writing of data into the flash ROM 26 and the reading of data from the flash ROM 26.

The DSP 16 is connected to the flash controller 24 via the bus 28, and processes, in real time, audio data having a high transfer rate that is read out from the flash ROM 26 by the flash controller 24. The SRC 18 converts the sampling frequency of the audio data that is input from the DSP 16. The DAC 20 converts the digital audio data that is input from the SRC 18 into analog data, and outputs this analog data to the audio output portion 30.

FIG. 2 is a block diagram showing the construction of the flash ROM 26. The flash ROM 26 includes a file system region 50 and a non-file system region 52. The user can access the file system region 50, but cannot access the non-file system region 52.

Folders are provided in the file system region 50 in advance, while no folders are provided in the non-file system region 52. When the audio player 100 is connected to a computer, the user can visually confirm the file system region 50 on the computer screen via a GUI (graphical user interface), but cannot visually confirm the non-file system region 52.

The file system region 50 includes an audio data storage region 51. The audio data storage region 51 stores audio data transferred from an external computer via the USB interface 32. Data other than audio data, such as firmware, is saved in an area of the file system region 50 other than the audio data storage region 51.

The non-file system region 52 includes a system management data storage region 54, a boot loader program data storage region 56, a first firmware storage region 58, and a second firmware storage region 60. The system management data storage region 54 stores system management data that manages the entire system in the audio player 100. The boot loader program data storage region 56 stores boot loader program data that is automatically read out when the power supply of the audio player 100 is switched on.

The first firmware storage region 58 and second firmware storage region 60 store firmware. As will be described later, every time firmware is updated, updated new firmware (hereinafter also referred to as “updated firmware”) is alternately written in the first firmware storage region 58 and second firmware storage region 60.

Firmware includes a program for updating the firmware (hereinafter also referred to as “firmware updating program”). The updating of firmware according to the firmware updating program will be described below.

Hereinafter, the first firmware storage region 58 and second firmware storage region 60 are also collectively referred to as “firmware storage region.” In the present preferred embodiment, the non-file system region 52 preferably includes two firmware storage regions. However, the number of firmware storage regions is not limited to this, and a larger number of firmware storage regions may be included.

Firmware is updated, that is, saved in the file system region 50, by updated firmware being copied into either the first firmware storage region 58 or second firmware storage region 60 within the non-file system region 52. Conventionally, because the updated firmware is overwritten in the firmware storage region, the firmware that was saved in this storage region prior to this update is lost. Here, the CPU 10 that performs the copying of the updated firmware and the flash controller 24 that controls the copying function define the copying portion that copies the firmware written in the file system region 50 into a firmware storage region within the non-file system region 52.

The firmware update based on the construction as described above will be described below.

In cases where firmware is to be updated, the user (for example) first downloads updated firmware and a text file that describes the method for updating this updated firmware by connecting to the internet. The icons for the updated firmware and text file are respectively displayed on the computer screen. Afterwards, the user performs the operation for updating the firmware in accordance with the description in the text file. Following the above-mentioned download, the user connects the audio player 100 to the computer. When the audio player 100 is connected, the audio player 100 is detected on the basis of the Plug and Play function of the computer OS (operating system), and the folder icon indicating the audio player 100 is displayed on the screen.

The user moves the updated firmware icon to the folder icon indicating the audio player 100 on the computer screen preferably by a so-called drag and drop operation. In actuality, the folder indicating the audio player 100 corresponds to the file system region 50, so that the updated firmware is written into the file system region 50 as a result of the above-mentioned icon operation by the user. Thus, the user can save the firmware easily in the flash ROM 26 solely by means of the pre-existing function of the OS without using any separate computer software. Here, the CPU 10 writes the updated firmware into the file system region 50 and the flash controller 24 controls this writing function as the write portion that writes the updated new firmware into the file system region 50. While the updated firmware is being written, the progress status of the writing is displayed on the computer screen on the basis of the function of the OS. After confirming the completion of the writing of the firmware into the file system region 50 by means of this display, the user cuts the power supply of the audio player 100.

The copying of the firmware saved in the file system region 50 into the firmware storage region is performed when the power supply of the audio player 100 is switched on. When the user switches on the power supply of the audio player 100, the updating of the firmware is initiated by performing a specified operation for executing the firmware update, for example, by pressing the replay stop button simultaneously with the power button. Thus, as a result of the update being initiated only when the user performs a specified operation, it is possible to avoid an automatic update when the user does not wish to update the firmware. Furthermore, it is also possible to devise the system so that the firmware update is initiated when the power button is pressed.

When the user performs the above-mentioned operation for updating the firmware at the time of switching on the power supply, a signal indicating a firmware update request (hereinafter also referred to as “firmware update signal”) is stored in the SRAM 14 in an “on” state. When the power supply is switched on, the CPU 10 reads out a boot loader program from the boot loader program data storage region 56. A program for recognizing the updated firmware as the newest firmware when the previous firmware is updated is written into the boot loader program.

Next, the CPU 10 reads out the newest firmware from the firmware storage region that stores the newest firmware among the firmware storage regions in accordance with the boot loader program that has been read out. Here, the CPU 10 recognizes the newest firmware on the basis of the unique code contained in the updated firmware, the size of the firmware, or the like.

The CPU 10 determines the state of the firmware update signal stored in the SRAM 14 in accordance with the firmware updating program contained in the read firmware. When the CPU 10 determines that the firmware update signal is placed in an “on” state, the CPU 10 executes the updating of the firmware according to the firmware updating program. The CPU 10 first determines whether the updated firmware is saved in the file system region 50 on the basis of the unique extension assigned to the updated firmware, the unique code contained in the updated firmware, the size of the updated firmware, or the like.

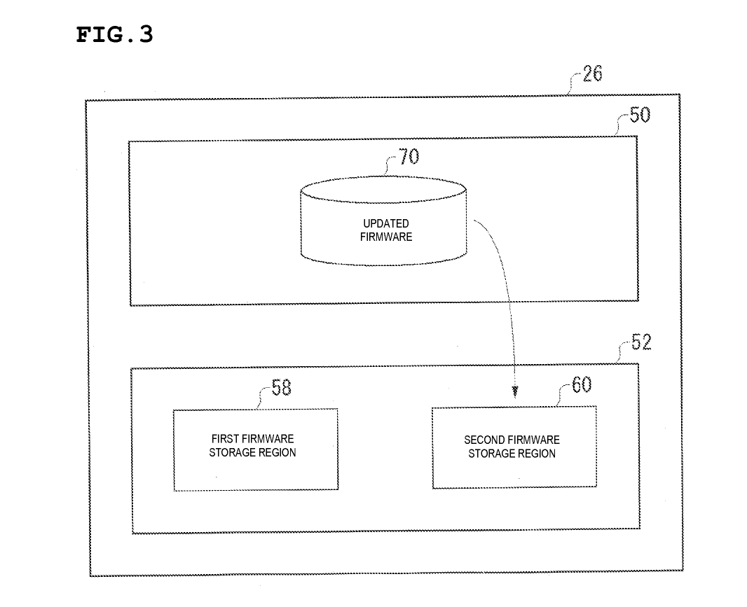

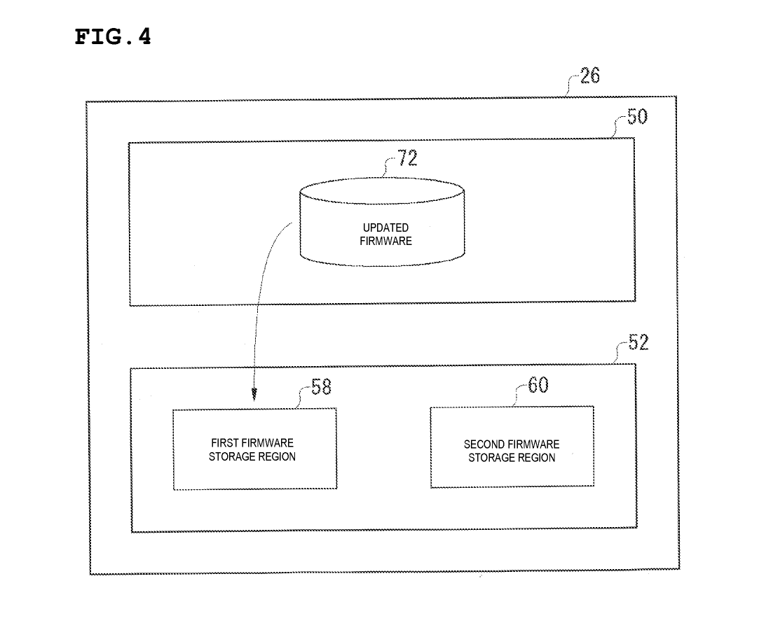

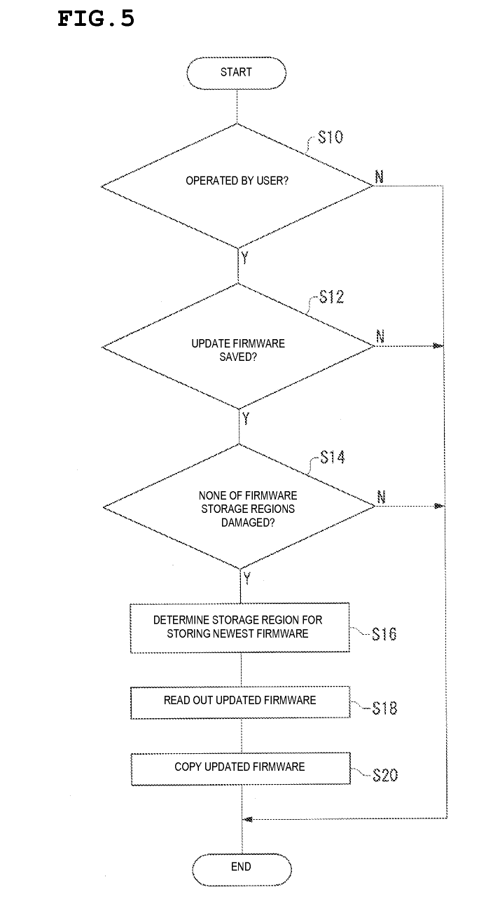

Moreover, the CPU 10 decides whether the updated firmware is to be copied into the first firmware storage region 58 or second firmware storage region 60 in the non-file system region 52. In specific terms, the CPU 10 recognizes the firmware storage region in which the newest firmware is not stored (among the first firmware storage region 58 and second firmware storage region 60) on the basis of the unique code contained in the updated firmware, the size of the updated firmware, or the like. Then, the CPU 10 decides that the updated firmware is to be copied into this firmware storage region. Here, the CPU 10 functions as the determination portion that determines the firmware storage region in which the newest firmware is stored among the plurality of firmware storage regions. The copying of the updated firmware will be described below with respect to FIGS. 3 and 4.

In addition, the CPU 10 decides the termination of the copying of the updated firmware in cases where either the first firmware storage region 58 or second firmware storage region 60 is damaged. As a result, in cases where there is only one firmware storage region operating normally, it is possible to avoid the non-operation of the electronic device due to firmware update failure caused by a failure to copy the updated firmware into this firmware storage region.

In the present preferred embodiment, the transfer of the updated firmware is terminated when either the first firmware storage region 58 or the second firmware storage region 60 is damaged. As a modified example, however, the updated firmware may also be copied into a storage region other than the damaged firmware storage region. As a result, there is no possibility of the updated firmware being copied into the damaged firmware storage region, so that firmware update failure can be avoided.

Furthermore, in cases where a firmware storage region is damaged, it would also be possible to inform the user by displaying a warning on the display portion (not shown) in the audio player 100. As a result, the user can make a judgment on whether or not the firmware update is to be performed when the firmware is updated in the future.

When the CPU 10 recognizes that the updated firmware is saved, the CPU 10 reads out the updated firmware from the file system region 50, and saves it in the SRAM 14. Next, the CPU 10 copies the updated firmware saved in the SRAM 14 into the firmware storage region that has been decided by the CPU 10 for the updated firmware to be copied. The firmware is updated as a result of this updated firmware being copied. Following the firmware update, when the user switches on the power supply of the audio player 100, the CPU 10 reads out the newest firmware, i.e., the above-mentioned updated firmware, into the SRAM 14 from the firmware storage region in accordance with the boot loader program. Then, the audio player 100 operates on the basis of this updated firmware. Here, the CPU 10 functions as the control portion which reads out the firmware that has been transferred to the firmware storage region within the non-file system region 52, and which operates the audio player 100 on the basis of this new read firmware.

Furthermore, after the updated firmware is copied into the firmware storage region from the file system region 50, the updated firmware icon is no longer displayed in the folder indicating the audio player 100 when the audio player 100 is connected to the computer. As a result, when the user further updates the firmware, it is possible to prevent the user from confusing the new firmware icon with the icon of the firmware that was saved at the previous update.

As was described above, after the user connects the audio player 100 to the computer, and copies the updated firmware into the audio player 100 using the function of the OS, if the user performs a specified operation such as the pressing of the replay stop button at the same time as the power button of the audio player 100, then the updating of the firmware is performed in the audio player 100 without the user performing any operation. That is, the user can update the firmware easily without using any updating-dedicated computer software. Furthermore, the user can update the firmware easily without being aware of the operation of the software used for update.

FIG. 3 is a diagram showing the concept of the first firmware update. Here, for the sake of simplicity of description, only the first firmware storage region 58 and second firmware storage region 60 are shown in the non-file system region 52 of the flash ROM 26. Updated firmware 70 is written into the file system region 50. Here, it is assumed that the firmware has never been updated, and that the initial firmware is stored in the first firmware storage region 58. In other words, no firmware is stored in the second firmware storage region 60. At this point, the initial firmware is stored in the first firmware storage region 58. That is, the updated firmware 70 is copied into the second firmware storage region 60. In FIG. 3, the arrow indicates the copying of the updated firmware 70 from the copy source into the copy destination.

FIG. 4 is a diagram showing the concept of the second firmware update. Second updated firmware 72 is written into the file system region 50. The second updated firmware 72 is a file in which the above-mentioned updated firmware 70 is to be updated.

Prior to the second firmware update, the initial firmware is stored in the first firmware storage region 58, and the updated firmware 70 is stored in the second firmware storage region 60. In other words, it is the second firmware storage region 60 where the newest firmware is stored at this point. Accordingly, the second updated firmware 72 is copied into the first firmware storage region 58. In FIG. 4, the arrow indicates the copying of the second updated firmware 72 from the copy source into the copy destination.

Updating of the firmware for the third time on is performed in the same manner as the second update. Specifically, the updated firmware is copied into the firmware storage region in which the newest firmware prior to this update is not stored (among the first firmware storage region 58 and second firmware storage region 60). For example, the second updated firmware 72, which is the newest firmware prior to the third update, is stored in the first firmware storage region 58. Accordingly, in the third update, the third updated firmware is copied into the second firmware storage region 60.

Thus, the updated firmware is copied into a firmware storage region other than the firmware storage region in which the newest firmware is stored. As a result, the firmware that is the newest prior to the current update is not lost, so that the use of the electronic device based on this firmware is ensured even if the electronic device has failed to copy the updated firmware.

FIG. 5 is a flow chart showing the firmware update. In cases where the power button and replay stop button are simultaneously pressed by the user (Y in S10) when the power supply of the audio player 100 is switched on, it is determined whether or not the updated firmware is saved in the file system region 50 (S12). On the other hand, when the above-mentioned power button and replay stop button are not pressed simultaneously (N in S10), no updating of the firmware is performed.

In cases where the updated firmware is saved in the file system region 50 (Y in S12), it is determined whether or not the first firmware storage region 58 and the second firmware storage region 60 are damaged (S14). On the other hand, in cases where the updated firmware is not saved in the file system region 50 (N in S12), no updating of the firmware is performed. When neither of the firmware storage regions are damaged (Y in S14), it is determined which of the firmware storage regions have the newest firmware stored therein (S16). Specifically, in S16, it is decided which of the firmware storage regions into which the updated firmware is to be copied. When the first firmware storage region 58 or second firmware storage region 60 is damaged (N in S14), the updating of the firmware is not performed.

Following the determination in S16, the updated firmware saved in the file system region 50 is read out to the SRAM 14 (S18). Next, this read updated firmware is copied into the firmware storage region in which the newest firmware is not stored (S20). As a result, the firmware is updated. Furthermore, the firmware update in the present preferred embodiment can still be performed even if the order of steps S10 and S12 and the order of steps S16 and S18 are respectively switched.

The present invention has been described above on the basis of a first preferred embodiment. This preferred embodiment is merely an exemplification; a person skilled in the art should understand that various modified examples are possible in the respective constituent elements and the combination of the respective processing steps, and that such modified examples are also within the scope of the present invention. For instance, modified examples such as those described below are conceivable.

In the present preferred embodiment, the control circuit 34 preferably is integrated on a single semiconductor substrate, but the present invention is not limited to this; the control circuit 34 may be integrated on a plurality of semiconductor substrates.

In the present preferred embodiment, an example is described in which the control circuit 34 is mounted on the audio player 100. As a modified example, however, it would also be possible to equip the control circuit 34 with a memory for a transceiver, two-dimensional bar code reader, or the like, and to mount such a circuit on an electronic device that is controlled by firmware stored in this memory.

In the present preferred embodiment, a firmware updating program was included in the firmware, but as a modified example, a firmware updating program may also be included in a boot loader program. In this case, when the user performs an operation for the above-mentioned firmware update at the time of switching on of the power supply, a firmware update signal is stored in the SRAM 14 in an “on” state. Once the CPU 10 recognizes the presence of the firmware update signal in an “on” state in the SRAM 14 in accordance with the firmware updating program included in the read boot loader program, the CPU 10 performs the updating of the firmware.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A control circuit for interacting with firmware that is stored in a memory, comprising:
a write portion arranged to write updated new firmware into a first region of the memory that is accessible to a user;
a copy portion arranged to copy the firmware written into the first region into a second region of the memory that is not accessible to the user; and
a control portion arranged to read out the firmware copied into the second region, and operate an electronic device including the control circuit on the basis of the read firmware.

2. The control circuit according to claim 1, wherein
the second region of the memory includes a plurality of firmware storage regions arranged to store the firmware;
the control circuit further comprises a determination portion arranged to determine a newest firmware storage region that stores the newest firmware among the plurality of firmware storage regions; and
the copy portion is arranged to copy the firmware into a firmware storage region other than the newest firmware storage region that is determined by the determination portion.

3. The control circuit according to claim 2, wherein the control portion is arranged to read out the newest firmware among the firmware stored in the plurality of firmware storage regions, and operate the electronic device on the basis of the newest read firmware.

4. The control circuit according to claim 2, wherein the copy portion is arranged to copy the firmware into a firmware storage region other than a damaged firmware storage region when there is a damaged firmware storage region among the plurality of firmware storage regions.

5. The control circuit according to claim 2, wherein the copy portion is arranged to terminate copying the firmware when there is only one storage region operating normally among the plurality of firmware storage regions.

6. The control circuit according to claim 2, wherein the copy portion is arranged to copy the firmware into the firmware storage region when a specified operation is performed by the user.

7. The control circuit according to claim 1, wherein the control circuit is integrated on a single semiconductor substrate.

8. An electronic device comprising:
the control circuit according to claim 1;
a memory arranged to store the firmware in the first region and audio data in the second region; and
an audio output portion arranged to replay the audio data stored in the second region.

9. A firmware update method for a device including a memory, wherein the method comprises:
writing updated new firmware into a first region of the memory that is accessible to the user; and
copying the firmware written into the first region into a second region of the memory that is not accessible to the user.

10. The firmware update method according to claim 9, wherein the second region of the memory includes a plurality of firmware storage regions for storing the firmware, and the method further comprises:
determining a newest firmware storage region that stores the newest firmware among the plurality of firmware storage regions; and
in the copying step, copying the firmware into a firmware storage region other than the newest firmware storage region determined in the determining step.

11. The firmware update method according to claim 10, wherein the method further comprises:
reading out the newest firmware among the firmware stored in the plurality of firmware storage regions; and
operating the electronic device on the basis of the newest read firmware.

12. The firmware update method according to claim 10, wherein the method further comprises:
copying the firmware into a firmware storage region other than a damaged firmware storage region when there is a damaged firmware storage region among the plurality of firmware storage regions.

13. The firmware update method according to claim 10, wherein the method further comprises:
terminating copying the firmware when there is only one storage region operating normally among the plurality of firmware storage regions.

14. The firmware update method according to claim 9, wherein the method further comprises:
copying the firmware into the firmware storage region when a specified operation is performed by the user.

15. A control circuit for interacting with software that is stored in a memory, comprising:
a write portion arranged to write updated new software into a first region of the memory that is accessible to a user;
a copy portion arranged to copy the software written into the first region into a second region of the memory that is not accessible to the user; and
a control portion arranged to read out the software copied into the second region, and operate an electronic device including the control circuit on the basis of the read software.
